(19) United States
(12) Patent Application Publication
(10) Pub. No.: US 2016/0263964 A1
(43) Pub. Date: Sep. 15, 2016

(54) MOTOR VEHICLE AIR-CONDITIONING SYSTEM WITH AN ADAPTIVE AIR VENT

(71) Applicant: AUDI AG, Ingolstadt (DE)

(72) Inventor: Christian WALL, Hitzhofen (DE)

(73) Assignee: AUDI AG, Ingolstadt (DE)

(21) Appl. No.: 15/036,373

(22) PCT Filed: Nov. 12, 2014
(86) PCT No.: PCT/EP2014/003027

§ 371 Date: May 12, 2016

(30) Foreign Application Priority Data
Nov. 15, 2013 (DE) 10 2013 019 197.1

(51) Int. Cl. B60H 1/00; B60H 1/34

(52) U.S. Cl. CPC B60H 1/00742; B60H 1/3414; B60H 1/00985; B60H 2001/3471

(57) ABSTRACT

A method for controlling an air-conditioning device in a motor vehicle includes the air-conditioning device conveying an air flow into a vehicle interior of the motor vehicle through at least one air outlet opening which is arranged on a lower side of an operating element designed to operate at least one device of the motor vehicle. A detection device detects and signals, by using a detection signal, if a user's hand is moved toward the operating element in order to actuate the operating element and/or if the operating element is actuated. The air-conditioning device then reduces and/or diverts the air flow.

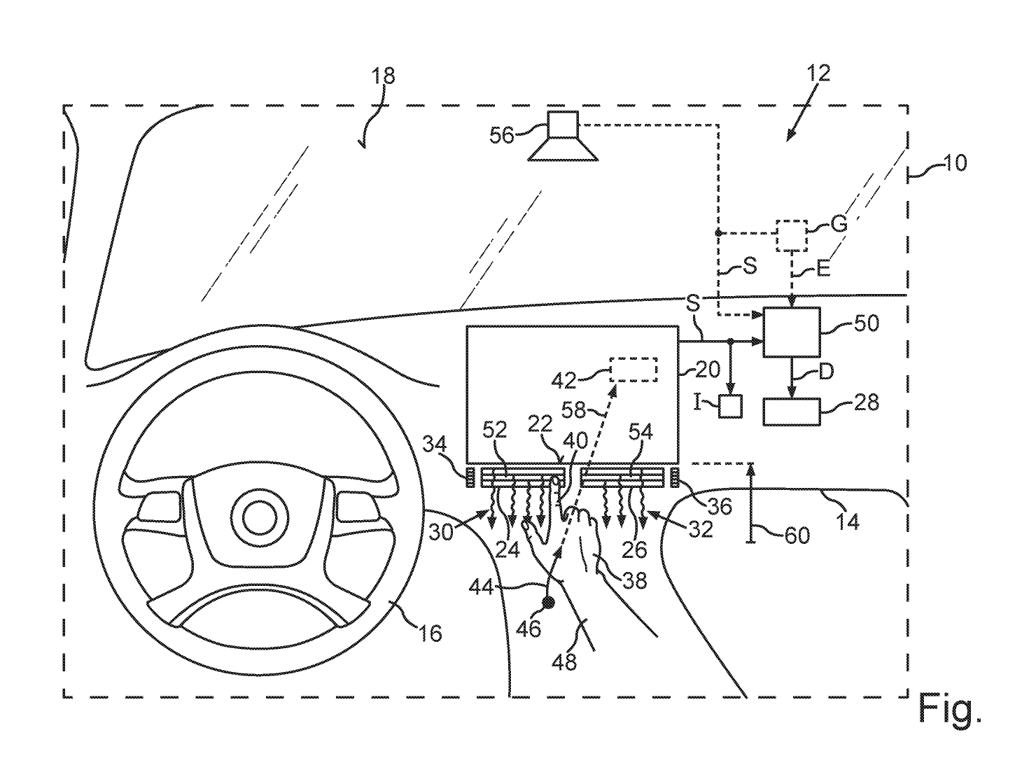

### CROSS REFERENCE TO RELATED APPLICATIONS

This application is a U.S. national stage of International Application No. PCT/EP2014/003027, filed on Nov. 12, 2014 and claims the priority benefit thereof. The International Application claims the priority benefit of German Application No. 10 2013 019 197.1 filed on Nov. 15, 2013. Both the International Application and German Application are incorporated by reference herein in their entirety.

### BACKGROUND

Described below is a method for controlling an air-conditioning device in a motor vehicle. In this case, the air-conditioning device is configured in a special manner to the effect that an air outlet opening, through which an air flow is blown into a vehicle interior of the motor vehicle, is arranged on a lower side of an operating element which can be used by a user to operate at least one device of the motor vehicle. In particular, the operating element may include a touchscreen which is arranged on a dashboard of the motor vehicle.

When positioning a touchscreen in a motor vehicle, it is necessary to find a compromise between readability and reachability. The touchscreen must be arranged high enough in order to allow the display contents to be viewed by the driver during a journey with an only slight aversion of his gaze from the traffic situation. On the other hand, the touchscreen must also be able to be easily reached by the hand in order to carry out an operating action, that is to say it must not be arranged too high or too far away from the driver. An ideal position is generally that location at which the adjustable directional air vents or air-conditioning outlets are arranged in the dashboard. The air-conditioning outlets have an outlet opening through which the air-conditioning device of the motor vehicle blows an air flow into the vehicle interior of the motor vehicle. In other words, the touchscreen and the adjustable directional air vents provided centrally in the motor vehicle compete for the same installation space when designing a motor vehicle. The adjustable directional air vents are usually situated above or laterally beside the touchscreen. If the adjustable directional air vents are situated to the side of the touchscreen, the width of the touchscreen is restricted. If the adjustable directional air vents are situated above the touchscreen, the installation height of the touchscreen is restricted.

However, the third solution, namely arranging the touchscreen above the adjustable directional air vents, is avoided nowadays since the user's hand is inevitably unpleasantly exposed to the air flow emerging from the air outlet opening while operating the touchscreen. This problem is generally present when designing a motor vehicle whenever an operating element, for example a touchscreen, has to be arranged above an air outlet opening of an air-conditioning device.

DE 10 2008 018 397 A1 discloses a method for controlling air-conditioning of an interior of a motor vehicle. According to the document, an item of state information relating to a body part of a vehicle occupant of the motor vehicle is determined and an air outflow from the air-conditioning is adjusted on the basis of a comfort criterion to be complied with and the acquired state information relating to the body part. This avoids the air flow which is blown in being unpleasantly blown into the vehicle occupant's face.

DE 10 2010 018 140 A1 describes a temperature adjusting apparatus for a motor vehicle, which has an integrated display.

DE 10 2006 009 303 A1 discloses a method for air-conditioning a motor vehicle, in which the occupant does not experience any direct incident flow.

DE 10 2012 003 311 A1 discloses a motor vehicle in which at least one parameter of a sitting position is read in and a ventilation temperature and/or an air distribution in the motor vehicle can be controlled on the basis of this parameter.

### SUMMARY

Described below is an arrangement of an operating element and an air outlet opening of an air-conditioning device in a motor vehicle, in which the operating element is arranged above the air outlet opening of the air-conditioning device.

The method described herein makes it possible to arrange an air outlet opening or a plurality of air outlet openings of an air-conditioning device on a lower side of an operating element. As a result, the operating element can have any desired configuration to the sides and toward the top without the at least one air outlet opening being in the way. The operating element itself need not necessarily have anything to do with the air-conditioning device. It may be an operating element designed to operate at least one other device of the motor vehicle. In particular, it may be the described touchscreen which can be used to operate an infotainment system of the motor vehicle, for example. In connection with the disclosure, a touchscreen can be understood as meaning a touch-sensitive screen, that is to say a screen which has, on its display surface, a sensor matrix which is used to detect touching or an approach or a pressure of a finger on the basis of the location.

In order to avoid the described disadvantage of the operating hand being in the air flow when operating the operating element, the method described herein provides for a detection device to signal, by using a detection signal, if the hand is moved toward the operating element in order to actuate the operating element and/or if the operating element is actuated. If the detection device generates the detection signal, the air flow emerging from the at least one air outlet opening is reduced and/or diverted to a side of the vehicle or downward, for example, by the air-conditioning device. The reduction in the air flow may cause, on the one hand, attenuation of the air flow and, on the other hand, also complete interruption of the air flow. In other words, the amount of air conveyed through the at least one air outlet opening per unit time is reduced by reducing the air flow. In order to reduce the air flow, the speed of a fan, for example, which drives or conveys the air flow can be reduced or the fan can be switched off during the operating process. The diversion can be achieved, for example, by using motor-pivotable fins in the at least one air outlet opening.

The method has the advantage that it is possible to operate the operating element by a hand without incident flow and new design possibilities are nevertheless enabled in the interior of the motor vehicle by arranging the operating element above an air outlet opening.

The detection device may be a signal-processing computing device, for example a control device or a microcontroller, and a suitable sensor system connected upstream. In this case, the sensor system detects or senses when the hand approaches the operating element and/or the operating process itself. According to one development of the method, the detection device generates the detection signal on the basis of an operating signal from the operating element itself. If the operating element is a pushbutton, for example, its switching signal can be used not only to control the associated device of the motor vehicle but also as a detection signal for the air-conditioning device when actuating the pushbutton. In the case of a touchscreen, the touch sensor system, that is to say the sensor matrix described, can accordingly be used to generate the operating signal. The use of the operating signal from the operating element itself has the advantage that it is possible to recognize in a very robust manner, without an additional sensor system, when there is a need to reduce and/or divert the air flow.

Another development of the method provides for the detection device to generate the detection signal on the basis of an additional sensor system different from the operating element. This is preferably a sensor system which is also provided for other functionalities of the motor vehicle, with the result that no additional sensor system likewise has to be installed. One development provides for the additional sensor system to include at least one of the following sensors: a video camera, an infrared camera, a time-of-flight camera (ToF camera), a capacitive sensor, and the like. These sensors have the advantage that it is already possible to contactlessly detect when the hand approaches the operating element. The cameras described may be provided, for example, by a gesture recognition device of the motor vehicle or a driver fatigue detection system. Their signals may also be supplied to a control device of the air-conditioning device in order to control the air flow on the basis of the camera signals.

An advantageous development results if the detection device generates the detection signal on the basis of a recognition signal from a gesture recognition device. This advantageously makes it possible to additionally check whether the hand has a predetermined posture and/or an extrapolated movement trajectory of the hand is aligned with the operating element. Monitoring the hand posture and detecting a particular hand shape, for example an index finger extended in order to touch the operating element, makes it possible to detect, in a particularly reliable manner, whether the user actually has a desire for operation, that is to say actually plans to operate the operating element. The “Kinect” function library from Microsoft can be used, for example, to detect a hand shape. Extrapolating a movement trajectory results in the advantage that it is already possible to detect at a very early stage whether the user is actually aiming for the operating element with his hand. As a result, the air flow can already be reduced and/or diverted when the hand passes an air outlet opening from below.

In order to obtain as few false recognitions as possible, one development of the method provides for the detection device to generate the detection signal on the basis of sensor signals from a plurality of sensors. In this case, a probability value is preferably determined for each sensor signal indicating that operation of the operating element is imminent. As a result, it is also possible to use sensor signals which, although constituting an indication of imminent operation of the operating element, are not unambiguous. The appropriate probability value can be determined in simple experiments by observing test subjects. The probability value therefore indicates that operation of the operating element is imminent. A total probability is then formed from the probability values of all evaluated sensor signals and the detection signal is generated only if the total probability value satisfies a predetermined triggering criterion, that is to say the total probability is, for example, above a predetermined threshold value, for example 70% or 80%.

However, reducing and/or diverting the air flow is not always useful. For example, a thumb wheel or another adjusting apparatus of the air-conditioning apparatus itself, which is provided for the purpose of adjusting the air flow, may be arranged at an air outlet opening itself. In this case, mechanically adjustable diverting blades or the thumb wheel mentioned may be present, for example, for the purpose of changing the cross section of the air outlet opening through which there is a flow. If the user now reaches for this adjusting apparatus in order to adjust the air flow, it does not make any sense to reduce the air flow or to guide it away from the hand. It is then no longer possible for the user to carry out an adjustment by using the adjusting apparatus. Therefore, one development of the method provides that, while an adjusting apparatus of the air-conditioning device, which is provided for the purpose of adjusting the air flow, is operated, the air flow is adjusted only on the basis of the operation of the adjusting apparatus and simply independently of the position of the hand and operation of the operating element. In other words, the air flow is therefore adjusted independently of a position of the hand and operation of the operating element while adjusting the air flow by using the adjusting apparatus. This results in the advantage that, during the adjustment, the user senses exactly that air flow which is also still generated by the air-conditioning device after the hand has been removed. In order to solve this problem of distinguishing between imminent operation of the operating element for a device of the motor vehicle, on the one hand, and the imminent operation of the adjusting apparatus of the air-conditioning device, on the other hand, in as simple a manner as possible, one development of the method provides for the detection signal to be generated only if the hand is above a particular minimum height, wherein the air outlet opening is below the minimum height. In other words, the user must therefore initially lift his hand above the minimum height before the detection signal is used to signal that actuation of the operating element is imminent. This height-dependent triggering can be implemented in a particularly reliable manner using the ToF camera already described. Capacitive sensors on or in the operating element or between the operating element and the at least one air outlet opening also make it possible to reliably detect a hand raised above the minimum height.

Another development of the method provides for the operating element to be a touchscreen, and for the air-conditioning device to not generally change the air flow in this case everywhere in the region of the at least one air outlet opening. The air-conditioning device changes the air flow on the basis of a location at which a finger of the hand touches the touchscreen only to the extent that a portion of the air flow flowing under the touch location is reduced and a remaining portion of the air flow remains unchanged. This makes it possible to achieve, for example, the situation in which only that portion of the air flow in which a hand is actually situated is reduced, while the remaining portion of the air flow which can flow past the hand without obstruction is also maintained without change.

A motor vehicle can be used to carry out the method according to the method described herein. In this case, the motor vehicle is preferably in the form of an automobile, in particular a passenger automobile, wherein the motor vehicle has an operating element designed to operate at least one device and an air-conditioning device. An air outlet opening for blowing air into a vehicle interior of the motor vehicle is arranged on a lower side of the operating element in the described manner. The motor vehicle has the described detection device for monitoring an operating desire of the user and for generating a detection signal. The motor vehicle may include an air-conditioning device designed to reduce and/or divert the air flow on the basis of the detection signal.

The described operating element of the motor vehicle may be a touchscreen which can be arranged, in particular, on a dashboard of the motor vehicle.

Additional developments of the motor vehicle may include features which have already been described in connection with the developments of the method. For this reason, the corresponding developments of the motor vehicle are not described again here.

### BRIEF DESCRIPTION OF THE DRAWINGS

These and other aspects and advantages will become more apparent and more readily appreciated from the following description of the exemplary embodiments, taken in conjunction with the accompanying drawing of which:

An exemplary embodiment in the single FIGURE shows a schematic illustration of an embodiment of the motor vehicle.

### DETAILED DESCRIPTION OF THE PREFERRED EMBODIMENT

In the exemplary embodiment, the described components of the embodiment are each individual features which can be considered independently of one another and each also develop the disclosure independently of one another and therefore can also be considered individually or in a combination other than the combination shown. Furthermore, the described embodiment can also be supplemented with further features which have already been described.

The FIGURE illustrates a vehicle interior 12 of a motor vehicle 10. A dashboard 14, a steering wheel 16 and a windshield 18 are shown. The dashboard 14 may have, for example in a manner arranged in the center of the vehicle, an operating element 20 which may be a touchscreen, for example. The operating element 20 can be used to operate an infotainment system I of the motor vehicle, for example. Air outlet openings 24, 26 through which an air-conditioning system 28 respectively blows or conveys an air flow 30, 32 into the vehicle interior 12 may be arranged on a lower side 22 of the operating element 20. A distance between the lower side 22 and the air outlet openings 24, 26 may be less than 15 cm, for example, in particular less than 10 cm, very particularly less than 5 cm.

An adjusting apparatus 34, 36, for example with a thumb wheel, can be respectively provided laterally beside the air outlet openings 24, 26 and can be used by an operator to manually regulate the respective air flow 30, 32 in a known manner. The air outlets 24, 26, the air-conditioning system 28 and the adjusting apparatuses 34, 36 together form an air-conditioning device.

In the example shown, a driver would like to carry out an operating action using his hand 38 on the touchscreen 20 in order to operate the infotainment system I, for example. For this purpose, the driver would like to use his extended index finger 40 to tap, for example, on a graphical object 42, which may be an operating panel (button) or a menu entry for example, on the touchscreen 20. For this purpose, the driver moves his hand 38 along a movement trajectory 44, for example from a position of rest 46, in the direction of the touchscreen 20. In this case, the driver must move his hand 38 through one or both of the air flows 30, 32. The driver holds his hand 38 or his forearm 48 in the region of the air flows 30, 32 even while operating the touchscreen 20, that is to say while tapping on the object 42, for example, and further graphical objects displayed on the touchscreen 20.

In the motor vehicle 10, however, it is ensured that the hand 38 and the arm 48 are not subjected to a hot or cold air flow 30, 32 in a manner perceived as unpleasant during the operating process. For this purpose, a detection device 50 is provided in the motor vehicle 10, which detection device may comprise, for example, a program module of the infotainment system I or of an intracentral computing device or of a control device. The detection device 50 senses when the hand 38 approaches the touchscreen and signals a detected approach and/or operation of the touchscreen 20 which has already been carried out to the air-conditioning system 28 by using a detection signal D.

The air-conditioning system 28 can then reduce the speed of a fan (not illustrated) of the air-conditioning system 28 or can switch off the fan, for example, on the basis of the detection signal D. In this case, the fan is that device which drives at least one of the air flows 30, 32. Additionally or alternatively, provision may also be made for fins 52, 54 arranged in the air outlet openings 24, 26 to be motor-adjusted on the basis of the detection signal D, with the result that the air flows 30 and/or 32 are diverted and, as a result, are guided past the hand 38 and the arm 48. Solely diverting the air flows 30, 32 results in the additional advantage that the amount of air conveyed into the vehicle interior 12 overall per unit time remains unchanged and the air-conditioning performance is not impaired thereby.

In order to detect when the hand 38 approaches the touchscreen 20, a signal S from a camera 56 of the motor vehicle 10 can be received by the detection device 50, for example, and the hand 38 can be detected in the vehicle interior 12 using the camera signal. Provision may be made, for example, for the movement trajectory 44 of a geometrical center of gravity of the hand 38, for example, to be detected using the camera signal S and for the movement trajectory 44 to be extended by using an extrapolation 58 and for a check to be carried out thereby in order to determine whether the hand 38 is moving toward the operating element 20. This is then recognized by the detection device 50 as an operating intention of the driver and the detection signal D is generated.

Provision may also be made for an operating signal from the operating element 20 itself to be evaluated by the detection device 50 as a further sensor signal S and therefore for the detection signal D to be generated during operation of the operating element 20, that is to say while the object 42 is being pressed, for example.

The camera 56 may also be a ToF camera, for example a PMD camera (PMD—Photonic Mixing Device). This also makes it possible to evaluate, for example, an item of height information relating to the position of the hand 38 in the vehicle interior 12. Provision may be made for the detection signal D not to be generated as long as the hand 38 is below a predetermined minimum height 60 below the lower side 22. As a result, it is then possible for the driver to operate the adjusting apparatuses 34, 36 without the air flows 30, 32 already being changed on account of an unintentionally generated detection signal as a result of the hand 38 approaching the adjusting apparatuses 34, 36.

In the example shown, the graphical object is situated on a right-hand side above the air outlet opening 26. Provision may be made for the detection device 50 to signal, by using the signal D, that only the air flow 32 below the graphical object 42 is intended to be reduced and/or diverted. In other words, in this embodiment, the left-hand air flow 30 remains unchanged, while the driver, with his hand 38 on the touchscreen, uses his finger 40 to tap on the graphical object 42 on the right-hand half of the touchscreen 20. In this case too, the driver then does not sense any unpleasant air flow since the air flow 30 is not directed at his hand 38 or his arm 48.

Particularly early detection of the operating intention is also possible if the detection device 50 uses the position of the hand 38 to check whether the driver intends to operate the touchscreen 20. For this purpose, it is possible to check, for example, whether the index finger 40 has been extended for operation and to then generate the detection signal D only for this case. For this purpose, the motor vehicle 10 may have a gesture recognition device G which checks whether the hand has a predetermined gesture or position. If it is detected that the hand 38 has the position, this is signaled to the detection device 50 by the gesture recognition device G by using a recognition signal E. The gesture recognition device G may be, for example, a program module of a central computing device, of the infotainment system I or of the control device of the motor vehicle 10.

Overall, the example therefore shows how air-conditioning control can be achieved in a motor vehicle on the basis of the operation of a touchscreen in order to avoid the hand being exposed to a flow in a manner perceived as unpleasant during operation of the touchscreen. This makes it possible to also arrange the touchscreen above air outlet openings of the air-conditioning device.

A description has been provided with particular reference to embodiments thereof and examples, but it will be understood that variations and modifications may be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1.-11. (canceled)

12. A method for controlling an air-conditioning device in a motor vehicle, the method comprising:
conveying, by the air-conditioning device, an air flow into a vehicle interior of the motor vehicle through at least one air outlet opening arranged on an underside of an operating element configured to operate at least one device of the motor vehicle;
determining, by a detection device, whether to generate a detection signal based on at least one of whether a hand of a user is moved toward the operating element to actuate the operating element, whether the operating element is actuated, and whether a recognition signal is generated by a gesture recognition device which generates the recognition signal only if an extrapolated movement trajectory of the hand is aligned with the operating element;
generating the detection signal, by the detection device, based on the determining; and
adjusting, by at least one of reducing and diverting, the air flow conveyed by the air-conditioning device, based on the detection signal.

13. The method as claimed in claim 12, wherein determining whether to generate the detection signal by the detection device is based on an operating signal from the operating element.

14. The method as claimed in claim 12, wherein determining whether to generate the detection signal by the detection device is based on an additional sensor system different from the operating element.

15. The method as claimed in claim 14, wherein the additional sensor system comprises at least one of a video camera, an infrared camera, a ToF camera, and a capacitive sensor.

16. The method as claimed in claim 12, wherein
determining whether to generate the detection signal by the detection device further comprises:
receiving sensor signals from a plurality of sensors,
determining a probability value for each of the sensor signals indicating whether operation of the operating element is imminent; and
determining a total probability value from all probability values determined for each of the sensor signals; and
wherein the detection device generates the detection signal only if the total probability value satisfies a predetermined triggering criterion.

17. The method as claimed in claim 12, wherein
the air-conditioning device includes an adjusting apparatus arranged at the at least one air outlet opening and is configured to adjust the air flow, and
while operating the adjusting apparatus, adjusting the air flow independently of a position of the hand and actuation of the operating element, and based only on operation of the adjusting apparatus.

18. The method as claimed in claim 12, wherein
the at least one air outlet opening is below a predetermined minimum height, and
determining whether to generate the detection signal by the detection device further comprises determining to generate the detection signal only if the hand is above the predetermined minimum height.

19. The method as claimed in claim 12, wherein
the operating element is a touchscreen, and
adjusting the air flow conveyed by the air-conditioning device changes the air flow based on a location at which a finger of the hand touches the touchscreen by reducing a portion of the air flow flowing under the touch location and maintaining a remaining portion of the air flow flowing under the touch location.

20. A motor vehicle, comprising:
an operating element configured to operate at least one device of the motor vehicle;
an air-conditioning device having at least one air outlet opening arranged on an underside of the operating element and configured to convey an air flow into a vehicle interior of the motor vehicle; and
a detection device configured to determine whether to generate a detection signal based on at least one of whether a hand of a user is moved toward the operating element to actuate the operating element, whether the user actuates the operating element, and whether a recognition signal is generated by a gesture recognition device which generates the recognition signal only if an extrapolated movement trajectory of the hand is aligned with the operating element, and to generate the detection signal based on the determination,
the air-conditioning device being further configured to at least one of reduce and divert the air flow based on the detection signal.

21. The motor vehicle as claimed in claim 20, wherein the operating element is a touchscreen.

22. The motor vehicle as claimed in claim 20, wherein the operating element is a pushbutton.

23. The motor vehicle as claimed in claim 20, wherein the gesture recognition device is disposed at the motor vehicle and includes at least one camera to detect movement of the hand of the user.

24. The motor vehicle as claimed in claim 20, wherein the air-conditioning device diverts the air flow in a downward direction or to a side of the at least one air outlet opening, based on the detection signal.

25. The motor vehicle as claimed in claim 20, further comprising at least one manually operable adjusting apparatus configured to regulate air flow through the at least one air outlet opening,
wherein
when a user manually operates the adjusting apparatus, the air flow is adjusted by the adjusting apparatus based on the manual operation of the adjusting apparatus and independently of a position of the hand of the user and independently of actuation of the operating element.

26. The motor vehicle as claimed in claim 20, wherein
the operating element is a touchscreen, and
the gesture recognition device generates the recognition signal only if the extrapolated movement trajectory of the hand is aligned with an object displayed on the touchscreen.

27. The motor vehicle as claimed in claim 26, wherein the air-conditioning device at least one of reduces and diverts the air flow based on the location of the object displayed on the touchscreen relative to a location of the at least one air outlet opening.
